(19) United States
(12) Patent Application Publication
(10) Pub. No.: US 2019/0392252 A1
(43) Pub. Date: Dec. 26, 2019

(54) SYSTEMS AND METHODS FOR SELECTING A FORECAST MODEL FOR ANALYZING TIME SERIES DATA

(71) Applicant: New Relic, Inc., San Francisco, CA (US)

(72) Inventors: Guy FIGHEL, San Francisco, CA (US); Neta ATZMON, San Francisco, CA (US); Adva MOND, San Francisco, CA (US); Avishay WEINBAUM, San Francisco, CA (US)

(21) Appl. No.: 16/451,983

(22) Filed: Jun. 25, 2019

Related U.S. Application Data
(60) Provisional application No. 62/689,279, filed on Jun. 25, 2018.

(51) Int. Cl. G06K 9/62; G06F 17/18

(52) U.S. Cl. CPC G06K 9/6222; G06K 9/6242; G06K 9/6226; G06F 17/18

(57) ABSTRACT

Systems and methods for selecting a forecast model for analyzing time series data operate by identifying a characteristic of a set of time series data, then running tests on the time series data using multiple different forecast models. The forecast model that returns the fewest errors predicting future values of the time series data is selected for use for in analyzing time series data having the identified characteristic. This process is repeated for other sets of time series data having alternate characteristics to identify the forecast models that most accurately predict future values of time series data having those alternate characteristics. Thereafter, it is only necessary to identify the characteristics of a new set of time series data, and then use the forecast model that was selected for time series data having the identified characteristic in order to generate accurate predictions of future values for the new set of time series data.

This application claims priority to the filing date of U.S. Provisional Patent Application No. 62/689,279, which was filed on Jun. 25, 2018, the contents of which are hereby incorporated by reference.

### BACKGROUND

The present application discloses technology which is used to help a business keep a computer based production environment operating efficiently and with good performance. The “production environment” could be any of many different things. In some instances, the production environment could be a networked system of computer servers that are used to run an online retailing operation. In another instance, the production environment could be a computer system used to generate computer software applications. In still other embodiments, the production environment could be a computer controlled manufacturing system. Virtually any sort of production environment that relies upon computers, computer software and/or computer networks could benefit from the systems and methods disclosed in this application.

As computer-based production environments scale up and become larger, performance can decline. It becomes increasingly difficult to keep all portions of the system operating efficiently. There are many software applications that have been designed to monitor a production environment, and to report on key metrics and events. However, the data and reports generated by such monitoring applications can themselves be difficult to comprehend. It can be difficult to use such data and reports in a meaningful manner to restore peak performance. Also, when problems and issues arise in such a production environment, it can be very difficult for a system administrator to identify the root causes of the problems or issues based on the data and reporting provided by such a monitoring application.

One of the types of data reported by monitoring elements of a production environment is sets of time series data. This is essentially a metric or measurement that is taken repeatedly over an extended period of time. The set of measurements is called a set of time series data.

One of the major tasks in analyzing time series data is forecasting—making predictions of future values based on the previous sequence of observations. Time series forecasting in a Site Reliability Engineering (SRE) context is extremely valuable. High quality forecasts increase the ability to prevent downtime by addressing potential issues before they hit the production environment. Anomaly detection can be processed in real time by comparing the actual data being generated by the production environment with predicted values for an optimal operating production environment to thereby identifying data points that are far from their predicted values as anomalies.

There are many techniques available for forecasting time series data. These techniques include data mining, statistics, modeling, machine learning and artificial intelligence. However, a forecasting method or technique that is appropriate for one type of time series data might not be appropriate for another. Therefore, it is essential to select and use an appropriate forecast model when evaluating time series data to make predictions for future values.

In order to choose the most suitable forecast model for a specific set of time series data, it is necessary to deeply understand the time series data behavior. In order to gain that understanding, certain features of the data should be examined. Those features can include the presence of trend and/or seasonal components, correlations between past observations, the change over time of the mean and variance (often called stationarity), as well as other statistical measures. Aspects related to the structure of the data should also be weighed, such as the length of the time series data, the time intervals between observations/measurements, the time frame covered by a set of time series data, and whether there is data apparently missing from the time series data. This requires the use of time series analysis and statistical techniques, which usually demands an expert's set of skills. Indeed, data scientists often spend a considerable amount of time selecting a proper forecast model to use to analyze time series data by visualizing the data for detecting trend and seasonality, plotting autocorrelation functions, applying statistical hypothesis tests of stationarity, and identifying patterns.

Unfortunately, when a large production environment is generating a great deal of time series data, it is not feasible for forecast model selection to be executed manually. This problem only becomes more acute when a monitoring service is attempting to analyze time series data from a large number of different production environments. Traditionally, the individuals in charge of monitoring and analyzing production environments take a simpler approach and select a single forecast method which is used to evaluate all time series data. Of course, this approach fails to take into consideration the specific characteristics of individual sets of time series data. Due variation in the characteristics and properties of different sets of time series data, using only a single forecast model to evaluate all time series data can yield poor results.

### BRIEF DESCRIPTION OF THE DRAWINGS

FIG. 1 is a block diagram illustrating various elements of a production environment analysis system;

FIGS. 2A and 2B together form a diagram used to help explain methods of evaluating the accuracy of multiple different forecast models;

FIG. 3 is flow diagram illustrating steps of a method of selecting a forecast model;

FIG. 4 is a flow diagram illustrating steps of a portion of the method illustrated in FIG. 3 in greater detail;

FIG. 5 is a flowchart illustrating steps of a method of determining whether there is anomalous data in a set of time series data; and

FIG. 6 is a block diagram illustrating various elements of a computer system that could embody or be used to practice the invention.

### DETAILED DESCRIPTION

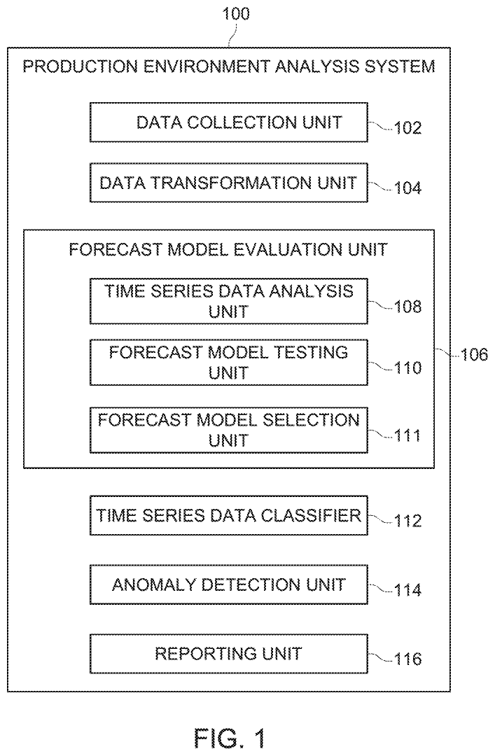

FIG. 1 illustrates various elements of a production environment analysis system 100 that receives or obtains data from one or more production environments, that analyzes that data to determine whether issues or problems may be occurring, and that reports on any identified problems or issues. The production environment analysis system 100 could be setup to monitor only one production environment. Alternatively, the production environment analysis system 100 could be used to monitor multiple different production environments.

A common aspirational goal of DevOps professionals is being proactive in identifying and addressing issues before they have any significant negative impact on a production environment. This requires the ability to make predictions about what reported data is typical or normal, and what data represents an anomaly. It is only possible to identify a problem if one can first determine that the data being reported from a production environment is not typical or normal.

As mentioned in the Background section above, there are many different types of forecast models that can be used to analyze time series data being reported from an element of a production environment and which can predict what future values should be for time series data from that element of the production environment, assuming nothing goes wrong. However, it is quite difficult for DevOps personnel to know which forecast model will provide the best results. Moreover, when DevOps personnel are dealing with large numbers of sets of time series data, it is literally impossible for them to make a manual selection of a forecast model for each individual set of time series data.

The systems and methods described below analyze various different forecast models using real world time series data. In these analysis methods, a first set of time series data is examined to determine what sort of characteristics the set of time series data has. Next, multiple different forecast models are used to analyze a first portion of the time series data and to predict what future values for the time series data should be. The predicted values are then compared to the real-world values for a second portion of the set of time series data to see how accurately each forecast model was able to predict what future values would be. Based on the analysis, the forecast model that had the least degree of error in predicting future values is selected as the forecast model to use when evaluating sets of time series data that exhibit the same characteristics as the test data set. This process can be repeated for different sets of time series data that exhibit various different characteristics in order to identify the best forecast models to use for sets of time data having various different characteristics.

Once the forecast models have been selected for sets of time series data having various different characteristics, a new set of time series data having a certain characteristic is automatically evaluated using the forecast model that was deemed most accurate for time series data having that characteristic. This relieves DevOps personnel from attempting to select the most appropriate forecast model for individual sets of time series data. This also results in the most appropriate forecast model being used to evaluate each set of time series data, resulting in more accurate predictions of what would be normal values for future sets of time series data. More accurate predictions of future normal time series data values, in turn, increases the ability of the DevOps personnel to identify anomalous data. Details of these systems and methods are described below.

The production environment analysis system 100 includes a data collection unit 102 that is responsible for receiving or obtaining data from a production environment. The data collection unit 102 would typically receive data via application programming interfaces (APIs) which have been installed and configured on the production environment. The APIs would be configured to automatically send certain types of data to the data collection unit 102 on a periodic or continuous basis. The data being sent by the APIs to the data collection unit 102 could include data points representative of various measurements of a production environment, as well as event data relating to events which have occurred on the production environment. The data collection unit 102 may also include elements that actively obtaining data from a production environment, either continuously or on a periodic basis.

The present application focuses on systems and methods that are used to evaluate sets of time series data, which is essentially a series of measurements relating to an element or aspect of a production environment that are taken over an extended period of time. Thus, while the data collection unit 102 of a production environment analysis system 100 may obtain or collect many different types of data relating to a production environment, in the description that follows we focus primarily on sets of time series data.

The types of time series data that is typically collected by a production environment analysis system 100 can be categorized in two main categories: (1) infrastructure monitoring; and (2) application performance management monitoring.

Infrastructure time series data relates to all the hardware, software, network resources and other services required for the existence, operation and management of an enterprise IT environment. Infrastructure tools monitor traditional IT metrics such as network performance, disk space and CPU and memory utilization.

Application performance management relates to the monitoring and management of the performance and availability of software applications. Application performance management tools detect and diagnose complex application performance problems to help maintain an expected level of service. The key metrics that are monitored typically include end user experiences as well as the computational resources used by the software application. The time series data generated in connection with application performance management can include data about client CPU utilization, memory demands, data throughput and bandwidth, as well as application performance data such as specific API calls, error rates and saturation.

The production environment analysis system 100 also includes a data transformation unit 104 that may transform received or collected time series data in some fashion before the time series data is used to help select a forecast model, and/or before the time series data is used to help predict future values and detect potential anomalies. The transformations made to time series data is intended to improve prediction performance. The transformations made by the data transformation unit 104 can include detrending the data, eliminating a seasonal component, applying techniques to make the data more stationary, such as differencing, logging, and decomposing the data by seasonal and trend decomposition using Loess (STL) and using the residuals. In addition, the data transformation unit 104 may make other adjustments to received time series data, such as replacing missing values, smoothing, filtering and/or normalizing the data.

The production environment analysis system 100 also includes a forecast model evaluation unit 106 that is responsible to selecting the most appropriate forecast model for use with sets of time series data having certain characteristics. The forecast model evaluation unit 106 includes a time series data analysis unit 108 that analyzes a set of time series data to determine what characteristics the time series data exhibits. The characteristics identified by the time series data evaluation unit 108 could include statistical properties such as mean, standard deviation, range and skewedness. The characteristics could also include seasonality, trend, stationarity, as well as others. The characteristics of a set of time series data identified by the time series data analysis unit 108 could be used to select the various different forecast models that will be tested using the time series data set.

Identifying certain characteristics can be complex and require a fair degree of analysis. For example, seasonality can be detected by using the Fourier transform of autocorrelation. Trend can be detected through regression analysis methods. Stationarity can be tested by using root tests, such as the Dickey-Fuller test.

The forecast model evaluation unit 106 also includes a forecast model testing unit 110, which uses a set of time series data to evaluate the accuracy of various different forecast models. The specific way that this is accomplished is described in detail below.

The forecast model evaluation unit 106 further includes a forecast model selection unit 111 that selects one of a plurality of forecast models that were tested by the forecast model testing unit 110 as the most appropriate forecast model to use for time series data sets having a certain characteristic or a certain set of characteristics. Essentially, the forecast model selection unit 111 selects the forecast model that most accurately predicts future data values for a set of time series data. This process is also explained in greater detail below.

The production environment analysis system 100 also includes a time series data classifier 112 that examines a newly received set of time series data and that determines which of multiple forecast models is likely to be the most accurate in predicting future values of the time series data. The time series data classifier 112 can make this determination by analyzing the received set of time series data to determine what characteristics it exhibits. The decision about which forecast model to use to predict future values can then be based on the identified characteristics of the set of time series data. The time series data classifier 112 may also use other information about a received set of time series data to decide which forecast model to select. For example, additional metadata from the time series data such as source, type and time. Moreover, human generated information that is specifically marked (tagged) on a stream of time series data may also be used.

An anomaly detection unit 114 uses a forecast model selected by the time series data classifier 112 for a newly received set of time series data for an element of a production environment to predict future values of the time series data for the same element of the production environment. The anomaly detection unit 114 then compares the predicted values to actual future values of time series data for the element of the production environment when such future time series data is received. If there appear to be discrepancies between the predicted values and the actual values, a reporting unit 116 reports the anomaly. DevOps personnel can then investigate the anomaly and determine if corrective action is required. Alternatively, the production environment analysis system 100 may be capable of taking remedial action without involving DevOps personnel.

The above description of elements of a production environment analysis system 100 focused only on elements that would be used to evaluate and select forecast models for time series data, and that could evaluate time series data using those forecast models. A production environment analysis system 100 embodying the invention could have many other elements and features in addition to those discussed above. In addition, a production environment analysis system 100 embodying the invention need not include all of the elements discussed above.

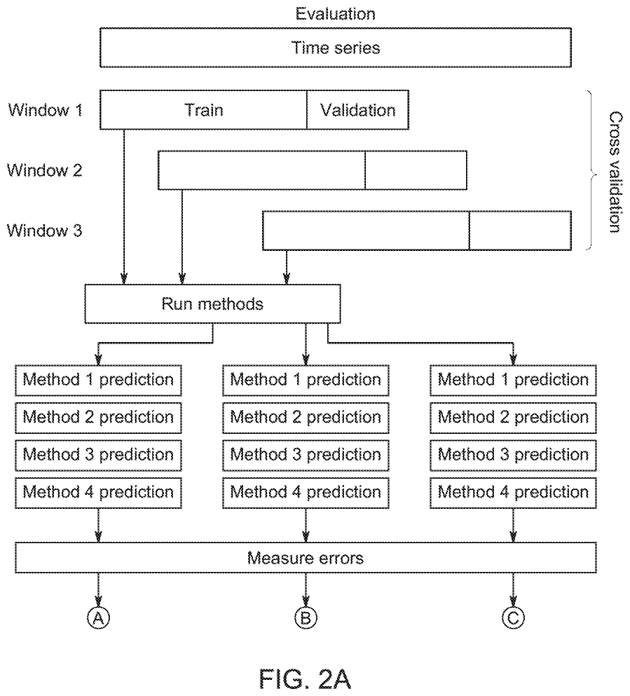

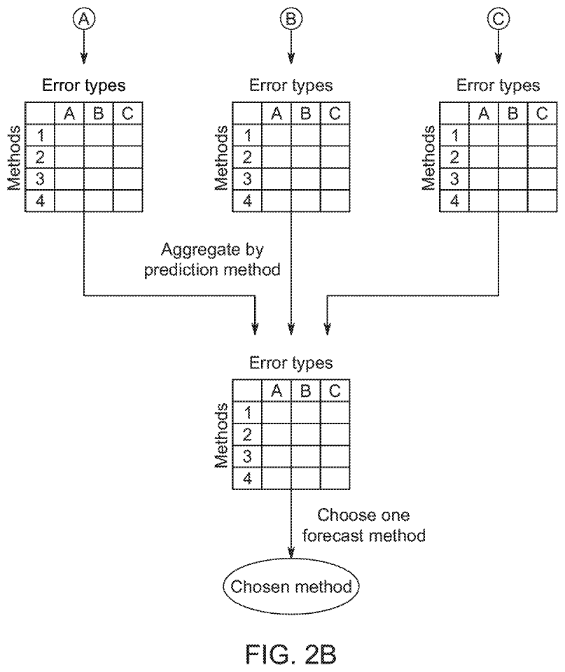

We will now turn to a description of methods of evaluating forecast models with references to FIGS. 2A-4.

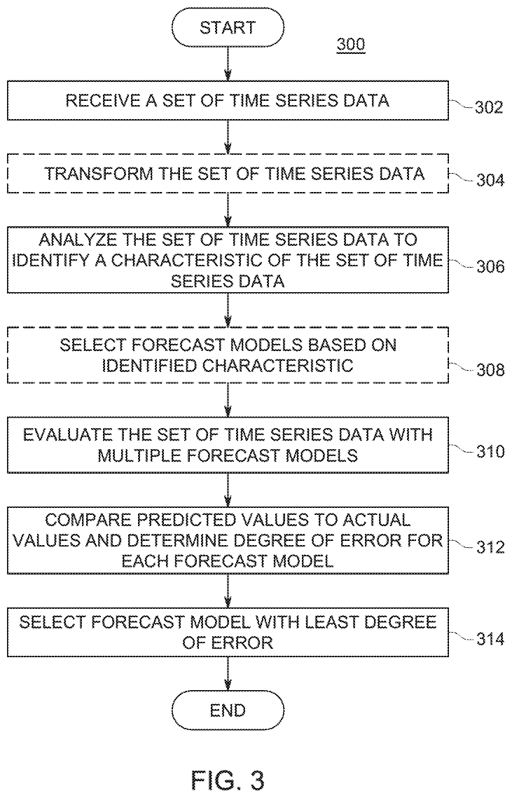

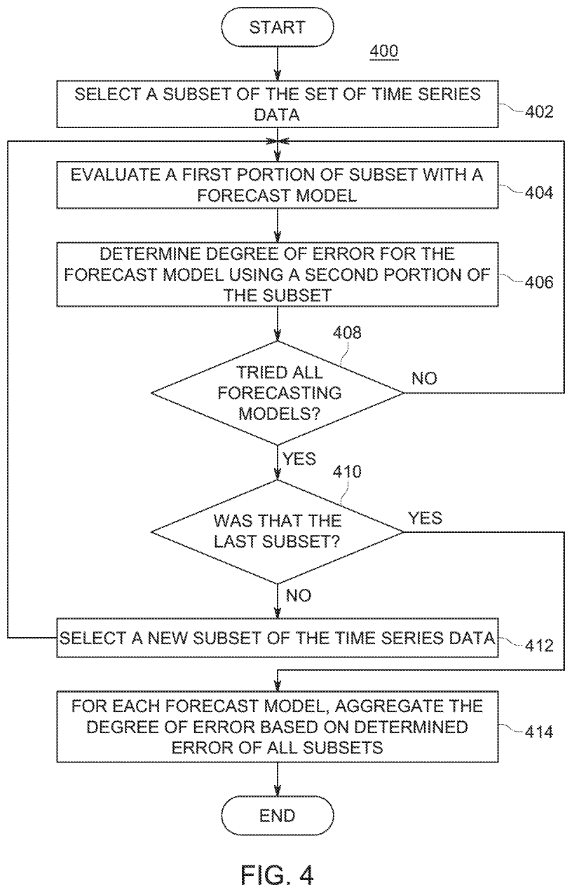

FIGS. 2A and 2B together form a diagram that helps to illustrate the forecast model evaluation process that is illustrated in the flowcharts of FIGS. 3 and 4. FIG. 3 illustrates steps of the method from a high level. FIG. 4 illustrates steps that provide greater detail about one embodiment of the invention that includes steps 310 and 312 of the method depicted in FIG. 3, in which multiple forecast models are evaluated in terms of their ability to accurately predict future values for time series data.

Referring to FIG. 3, the method 300 begins and proceeds to step 302, where a set of time series data is received by a data collection unit 102 of a production environment analysis system 100. Step 304 is an optional data transformation step that may or may not be performed, depending on circumstances. If step 304 is performed, a data transformation unit 104 would transform some of all of the values in the received set of time series data in an attempt to improve the performance of the forecast models that will be tested. As mentioned above, this can include detrending the data, eliminating a seasonal component, applying techniques to make the data more stationary, such as differencing, logging, and decomposing the data by seasonal and trend decomposition using Loess (STL) and using the residuals. In addition, the data transformation unit 104 may make other adjustments to received time series data, such as replacing missing values, smoothing, filtering and/or normalizing the data.

In step 306 the time series data analysis unit 108 of a forecast model evaluation unit 106 analyzes the data in the received set of time series data, or the transformed data if data transformation is performed in optional step 304, to identify one or more characteristics of the time series data. The characteristics can include statistical properties such as mean, standard deviation, range and skewedness. The characteristics can also include seasonality, trend and stationarity.

The time series data analysis unit 108 may also examine categorical information relating to a set of time series data. For example, metadata for a set of time series data can include textual information that can indicate the type of data contained in a stream of time series data, the device, application or element of a production environment that gave rise to the stream of time series data, the type of metric that was measured, the element or API that reported the stream of time series data, as well as various other aspects of the time series data. This information can also be considered along with characteristics of a set of time series data.

In step 308, which is an optional step, the characteristics and other information identified in step 306 are used to select a set of forecast models that will be tested with the received set of time series data. In some embodiments, this step is not performed, and a standard or default set of forecast models are tested.

In step 310, the forecast model testing unit tests the selected or default set of forecast models using the received set of time series data or using the transformed set of time series data if step 304 was performed. In part, this is accomplished by separating the set of time series data into two portions, a first portion that will be used by each forecast model to predict future values for the time series data, and a second portion that will be used to test the predictive accuracy of each forecast model.

In some embodiments, the entire set of time series data is separated into the first and second portions, and each forecast model is then used to predict future values for the time series data using the first portion of the set of time series data. The first portion could, for example, represent the first 80% of the time series data and the second portion could represent the last 20% of the time series data. Of course, other splits are possible. Also, if seasonality was detected in step 306, it may make sense to split up the set of time series data in a different fashion that better accounts for the seasonality.

Note, an alternate technique for testing each of the forecast models is described below in connection with FIG. 4. In that alternate method, multiple subsets of the received set of time series data is used to test each forecast model multiple times, and the results are then summarized. Details of this alternate method are provided below.

The forecast models could use regression methods, such as the AutoRegressive Integrated Moving Average (AIRMA) technique. An AutoRegressive model uses a dependent relationship between an observation and some number of lagged observations. An Integrated model uses the differencing of raw observations, e.g. subtracting one observation (measurement) from the previous observation in the time series. Differencing in this matter is a transformation that can be applied to time series data to make it stationary. This allows the properties to not depend on the time of observation, eliminating trend, seasonality and stabilizing the mean of the time series. A Moving Average model uses the dependency between an observation and a residual error from a moving average model applied to lagged observations.

The forecast models could also use various other techniques, such as a Holt-Winters analysis (additive and multiplicative), simple exponential smoothing, Fourier extrapolation, neural networks as well as other techniques to predict the future values of the time series data. Of course, other forecast models using other analysis techniques could also be used.

In step 312, the predicted values for future time series data that were generated by each of the forecast models is compared to the second portion of the set of time series data, which are the actual future values. Errors or discrepancies between the predicted values and actual values of the second portion of the set of time series data are determined or calculated. This can include calculating multiple different types errors for each of the forecast models, and then combining the multiple calculated errors in some fashion to generate a final error value for each forecast model. Some types of calculated error may be considered more problematic than other types of error. Thus, the various forms of error calculated for each forecast model may be input to a weighted equation to generate a final error value for each forecast model.

Errors could be calculated or determined using root mean square error, relative mean absolute error, mean absolute percentage error, mean absolute scaled error, as well as measures.

In step 314, the forecast model selection unit 111 uses the error values calculated for each forecast model to select the forecast model that provided the best predictions for future values of the time series data. This can be accomplished by simply selecting the forecast model with the least overall error. Alternatively, a final error value for each forecast model that is generated using multiple error values may be used to make a final determination about which of the forecast models provided the best prediction of future values for the time series data.

Note, the forecast model that is selected in step 314 is the model that is determined to be the best predictor for future values for time series data having the characteristics identified in step 306. This entire process can be repeated multiple times to test the forecast models against other sets of time series data having alternate characteristics to determine which of the forecast models are the best predictors for future values of time series data having those alternate characteristics.

As mentioned above, the forecast models could also be tested using multiple subsets of the received time series data. FIG. 4 illustrates steps of an alternate method of testing the forecast models in this fashion. Note, the steps depicted in FIG. 4 would correspond to steps 310 and 312 of the method depicted in FIG. 3. Also, FIGS. 2A and 2B graphically illustrate this alternate method of evaluating the forecast models via the method depicted in the flowchart of FIG. 4.

The steps depicted in FIG. 4 would be performed after a received set of time series data has been analyzed to determine whether it exhibits certain characteristics (step 306 of FIG. 3), and after a set of forecast models have been selected for testing. The method 400 proceeds to step 402, where a first subset of the entire set of time series data is selected. FIG. 2A illustrates that the forecast models will be tested three times using three different subsets of the time series data. However, a larger or smaller number of subsets of the time series data could also be used.

The subsets could be selected in various different ways. In the method illustrated in FIG. 2A, the three subsets all have the same size/duration, and the time gaps between each subset are the same. Each subset is separated into a first portion and a second portion. In the method depicted in FIG. 2A, the first portions of each subset have the same size, and the second portions of each subset have the same size. In alternate embodiments, each subset could be separated into different sized first and second portions.

Each of the subsets is then separately tested using each of the forecast models. Thus, the method proceeds to step 404, where the first portion of the first subset is tested with the first forecast model to predict future values for the time series data. In step 406, the predicted values are compared to the actual values in the second portion of the first subset, and one or more error values are calculated for the first forecast model's predictive performance against the first subset of the time series data.

In step 408 a check is performed to determine if all of the forecasting models have been tested against the first subset of time series data. If not, the method loops back to step 404 and a new forecast models is used to predict future values for the time series data using the first portion of the first subset of time series data. In step 406 the predicted values generated by the second forecast model are compared to the actual data in the second portion of the first subset of time series data, and one or more error values are calculated for the predictions made by the second forecast model. Steps 404-406 repeat until all of the forecast models have been tested against the first subset of the time series data, and error values have been calculated for each of the forecast models for their performance against the first subset of the time series data. Once that has been accomplished, the check preformed in step 408 will return a yes value, and the method proceeds to step 410.

In step 410 a check is performed to determine if all of the subsets have been tested. If not, the method proceeds to step 412, where a second subset of the time series data is selected. The method then loops back to step 404 where the first portion of the second subset of the time series data is used by the first forecast model to generate predicted future values for the time series data. Steps 404-406 are repeated as each of the forecast models is tested against the second subset of the time series data, and one or more error values are calculated for each of the forecast models' performance against the second subset of the set of time series data.

The above-described process will repeat until all of the forecast models have been tested against all of the subsets of the time series data, at which point the check performed in step 410 will return a yes value. The method then proceeds to step 414, where for each forecast model, an aggregate degree of error is calculated using the forecast models' error values that were calculated for each of the subsets of the time series data.

The technique illustrated in FIGS. 2A, 2B and 4 can generally be described as cross-validation. The cross-validation testing methods could be adjusted to select various different numbers of subsets of a set of time series data. The subsets need not all be the same size. Also, the way in which each subset is separated into a first portion and a second portion need not be the same for all subsets. Thus, the depiction provided in FIGS. 2A, 2B and 4 should in no way be considered limiting of the cross-validation techniques.

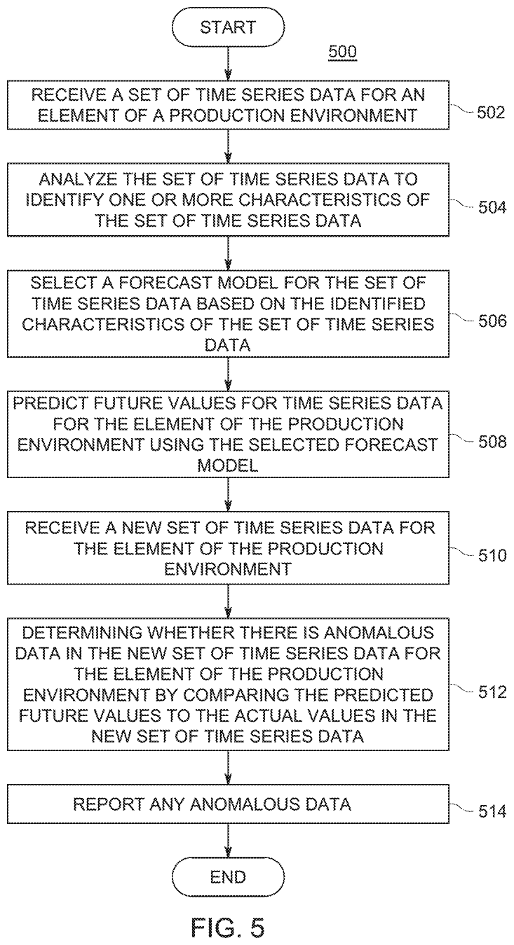

The methods described above allow a production environment analysis system 100 to identify forecast models that are accurate in predicting future values of time series data for time series data having certain characteristics. Once this has been accomplished, the production environment analysis system 100 can automatically select and use a forecast model to predict future values of a newly received set of time series data. One such method is depicted in FIG. 5.

The method 500 begins and proceeds to step 502, where the data collection unit 102 receives a new set of time series data for an element of a production environment. In step 504 a time series data classifier 112 of the production environment analysis system 100 analyses the received set of time series data to determine if it has one or more characteristics. The time series data classifier 112 may also examine categorical information relating to a set of time series data. For example, metadata for a set of time series data can include textual information that can indicate the type of data contained in a stream of time series data, the device, application or element of a production environment that gave rise to the stream of time series data, the type of metric that was measured, the element or API that reported the stream of time series data, as well as various other aspects of the time series data.

In step 506, the result of the analysis performed in step 504 is used to select a forecast model that is believed to accurately predict future values of time series data for time series data having the characteristics of the received time series data identified in step 504.

In step 508 the anomaly detection unit 114 of the production environment analysis system 100 uses the selected forecast model and the received set of time series data to predict future values for time series data for the element of the production environment. In step 510, the data collection unit 102 receives a new set of time series data for the element of the production environment. In step 512, the anomaly detection unit 114 then compares the predicted values for time series data for the element of the production environment to the actual values in the newly received set of time series data to determine if the data in the new set of time series data appears to contain any anomalies. Any significant variation between the predicted values and the actual values in the new set of time series data could be considered an anomaly. If such anomalies exist, they are reported to DevOps personnel in step 514. The method then ends.

The invention may be embodied in methods, apparatus, electronic devices, and/or computer program products. Accordingly, the invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

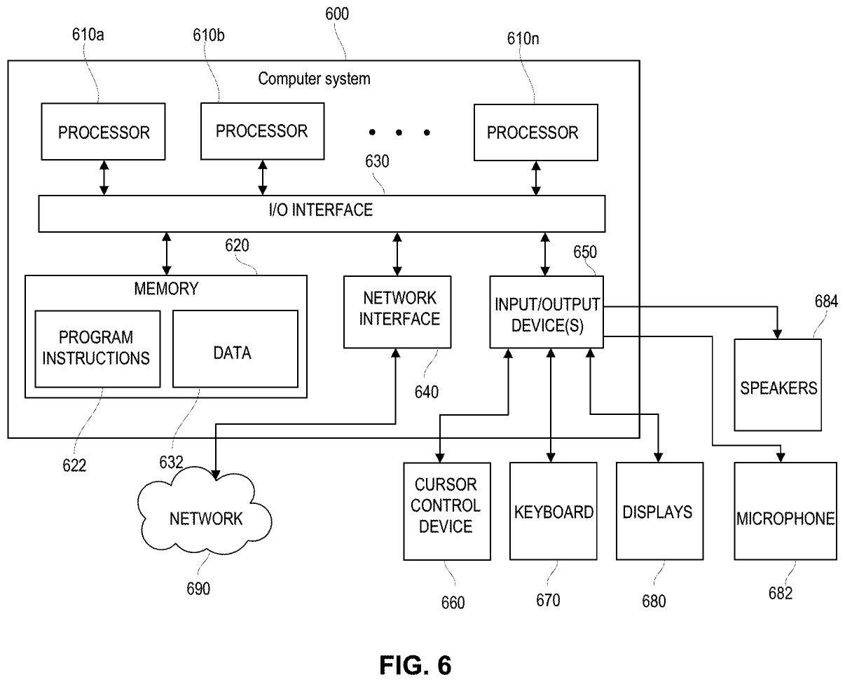

FIG. 6 depicts a computer system 600 that can be utilized in various embodiments of the present invention to implement the invention according to one or more embodiments. The various embodiments as described herein may be executed on one or more computer systems, which may interact with various other devices. One such computer system is the computer system 600 illustrated in FIG. 6. The computer system 600 may be configured to implement the methods described above. The computer system 600 may be used to implement any other system, device, element, functionality or method of the above-described embodiments. In the illustrated embodiments, the computer system 600 may be configured to implement the disclosed methods as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, an input/output devices interface 650. The input/output devices interface 650 facilitates connection of external I/O devices to the system 600, such as cursor control device 660, keyboard 670, display(s) 680, microphone 682 and speakers 684. In various embodiments, any of the components may be utilized by the system to receive user input described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, the computer system 600 may be any of various types of devices, including, but not limited to, a personal computer system, desktop computer, laptop, notebook, or netbook computer, a portable computing device, a mainframe computer system, handheld computer, workstation, network computer, a smartphone, a camera, a set top box, a mobile device, a consumer device, video game console, handheld video game device, application server, storage device, a peripheral device such as a switch, modem, router, or in general any type of computing or electronic device.

In various embodiments, the computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices interface 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

External input/output devices interface 650 may, in some embodiments, include one or more display terminals, keyboards, keypads, touchpads, scanning devices, voice or optical recognition devices, or any other devices suitable for entering or accessing data by one or more computer systems 600. Multiple input/output devices may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the operations and methods described above, such as the methods illustrated by the flowcharts of FIGS. 3-5. In other embodiments, different elements and data may be included.

Those skilled in the art will appreciate that the computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

In many of the foregoing descriptions, a software application running on a telephony device may perform certain functions related to the disclosed technology. In alternate embodiments, a browser running on the telephony device may access a software application that is running on some other device via a data network connection. For example, the software application could be running on a remote server that is accessible via a data network connection. The software application running elsewhere, and accessible via a browser on the telephony device may provide all of the same functionality as an application running on the telephony device itself. Thus, any references in the foregoing description and the following claims to an application running on a telephony device are intended to also encompass embodiments and implementations where a browser running on a telephony device accesses a software application running elsewhere via a data network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of selecting a forecast model for analyzing time series data, comprising:
receiving a set of time series data that is indicative of the performance of a production environment;
analyzing the set of time series data to identify a first characteristic of the set of time series data;
evaluating the set of time series data with each of a plurality of forecast models, where the step of evaluating the set of time series data comprises, for each of the plurality of forecast models:
evaluating a first portion of the set of time series data with one of the forecast models to generate predicted future values of the time series data, and
comparing the predicted future values of the time series data to a second portion of the set of time series data to determine a degree of error between the predicted future values of the time series data and the second portion of the set of time series data; and
selecting the forecast model that had the smallest degree of error between the predicted future values of the time series data and the second portion of the set of time series data as a first forecast model to use in the future to analyze time series data having the first characteristic.

2. The method of claim 1, wherein the step of evaluating the set of time series data with each of a plurality of forecast models comprises, for each of the plurality of forecast models:
selecting a time window comprising a subset of the set of time series data;
evaluating a first portion of the subset of the set of time series data with one of the forecast models to generate predicted future values of the time series data;
comparing the predicted future values of the time series data to a second portion of the subset of the set of time series data to determine a degree of error between the predicted future values of the time series data and the second portion of the subset of the set of time series data; and
repeating the selecting, evaluating and comparing steps for at least one additional time window that comprises a different subset of the set of time series data.

3. The method of claim 2, wherein the step of selecting the forecast model comprises:
combining, for each of the forecast models, the degrees of determined error between the predicted future values of the time series data and the second portion of the subsets of the set of time series data to create a composite degree of error for each of the forecast models; and
selecting the forecast model that had the smallest composite degree of error as the forecast model to use in the future to analyze time series data having the first characteristic.

4. The method of claim 1, further comprising transforming the set of time series data before performing the evaluating step, wherein transforming the set of time series data comprises at least one of detrending the data, reducing a seasonal component of the data, smoothing the data and/or normalizing the data.

5. The method of claim 1, further comprising selecting the plurality of different forecast models to be used in the evaluating step based on the result of the analyzing step.

6. The method of claim 1, where the step of analyzing the set of time series data to identify a characteristic of the set of time series data comprises analyzing the set of time series data to identify at least one of a statistical property of the set of time series data, a seasonality of the set of time series data, a trend of the set of time series data and/or a stationarity of the set of time series data.

7. The method of claim 6, wherein the step of analyzing the set of time series data further comprises analyzing the set of time series data to identify at least one of: a type of data contained in the set of time series data; an identity of a device, software application or element of a production environment that gave rise to the set of time series data; a metric that was measured to generate the set of time series data; and/or an identity of an element or application programming interface that reported the set of time series data.

8. The method of claim 1, wherein the step of analyzing the set of time series data to identify a characteristic of the set of time series data comprises analyzing the set of time series data to identify at least one of: a type of data contained in the set of time series data; an identity of a device, software application or element of a production environment that gave rise to the set of time series data; a metric that was measured to generate the set of time series data; and/or an identity of an element or application programming interface that reported the set of time series data.

9. The method of claim 1, wherein determining a degree of error between the predicted future values of the time series data and the second portion of the set of time series data comprises calculating at least one of root mean square error, relative mean absolute error, mean absolute percentage error and/or mean absolute scaled error.

10. The method of claim 1, further comprising:
receiving a new set of time series data that has a second characteristic; and
repeating the evaluating the selecting steps using the new set of time series data to select a second forecast model to use in the future to analyze time series data having the second characteristic.

11. A system for selecting a forecast model for analyzing time series data, comprising:
means for receiving a set of time series data that is indicative of the performance of a production environment;
means for analyzing the set of time series data to identify a first characteristic of the set of time series data;
means for evaluating the set of time series data with each of a plurality of forecast models, where evaluating the set of time series data comprises, for each of the plurality of forecast models:
evaluating a first portion of the set of time series data with one of the forecast models to generate predicted future values of the time series data, and
comparing the predicted future values of the time series data to a second portion of the set of time series data to determine a degree of error between the predicted future values of the time series data and the second portion of the set of time series data; and
means for selecting the forecast model that had the smallest degree of error between the predicted future values of the time series data and the second portion of the set of time series data as a first forecast model to use in the future to analyze time series data having the first characteristic.

12. A system for selecting a forecast model for analyzing time series data, comprising:
a data collection unit configured to receive a set of time series data that is indicative of the performance of a production environment;
a time series data analysis unit that analyzes the set of time series data to identify a first characteristic of the set of time series data;
a forecast model testing unit that evaluates the set of time series data with each of a plurality of forecast models, where evaluating the set of time series data comprises, for each of the plurality of forecast models:
evaluating a first portion of the set of time series data with one of the forecast models to generate predicted future values of the time series data, and
comparing the predicted future values of the time series data to a second portion of the set of time series data to determine a degree of error between the predicted future values of the time series data and the second portion of the set of time series data; and
a forecast model selection unit that selects the forecast model that had the smallest degree of error between the predicted future values of the time series data and the second portion of the set of time series data as a first forecast model to use in the future to analyze time series data having the first characteristic.

13. The system of claim 12, wherein for each of the plurality of forecast models, the forecast model testing unit:
selects a time window comprising a subset of the set of time series data;
evaluates a first portion of the subset of the set of time series data with one of the forecast models to generate predicted future values of the time series data;
compares the predicted future values of the time series data to a second portion of the subset of the set of time series data to determine a degree of error between the predicted future values of the time series data and the second portion of the subset of the set of time series data; and
repeats the selecting, evaluating and comparing steps for at least one additional time window that comprises a different subset of the set of time series data.

14. The system of claim 13, wherein the forecast model selection unit:
combines, for each of the forecast models, the degrees of determined error between the predicted future values of the time series data and the second portion of the subsets of the set of time series data to create a composite degree of error for each of the forecast models; and
selects the forecast model that had the smallest composite degree of error as the forecast model to use in the future to analyze time series data having the first characteristic.

15. The system of claim 12, further comprising a data transformation unit that transforms the set of time series data, wherein transforming the set of time series data comprises at least one of detrending the data, reducing a seasonal component of the data, smoothing the data and/or normalizing the data.

16. The system of claim 12, further comprising selecting the plurality of different forecast models that will be tested by the forecast model testing unit based on analysis performed by the time series data analysis unit.

17. The system of claim 12, where the time series data analysis unit analyzes the set of time series data to identify at least one of a statistical property of the set of time series data, a seasonality of the set of time series data, a trend of the set of time series data and/or a stationarity of the set of time series data.

18. The system of claim 17, wherein the time series data analysis unit also analyzes the set of time series data to identify at least one of: a type of data contained in the set of time series data; an identity of a device, software application or element of a production environment that gave rise to the set of time series data; a metric that was measured to generate the set of time series data; and/or an identity of an element or application programming interface that reported the set of time series data.

19. The system of claim 12, wherein the forecast model testing unit determines a degree of error between the predicted future values of the time series data and the second portion of the set of time series data by calculating at least one of root mean square error, relative mean absolute error, mean absolute percentage error and/or mean absolute scaled error.

20. The system of claim 12, wherein the data collection unit is also configured to receiving a new set of time series data that has a second characteristic, wherein the time series data analysis unit is also configured to analyze the new set of time series data to identify a second characteristic of the new set of time series data, wherein the forecast model testing unit is configured to evaluate the new set of time series data with each of a plurality of forecast models, where evaluating the new set of time series data comprises, for each of the plurality of forecast models:
evaluating a first portion of the set of time series data with one of the forecast models to generate predicted future values of the time series data, and
comparing the predicted future values of the time series data to a second portion of the set of time series data to determine a degree of error between the predicted future values of the time series data and the second portion of the set of time series data; and
wherein the forecast model selection unit is also configured to select the forecast model that had the smallest degree of error between the predicted future values of the new set of time series data and the second portion of the new set of set of time series data as a second forecast model to use in the future to analyze time series data having the second characteristic.
